(19) United States
(12) Patent Application Publication
(10) Pub. No.: US 2007/0130006 A1
(43) Pub. Date: Jun. 7, 2007

(54) Point of sale terminal with advertising panels

(75) Inventor: Oyvind Dahl, Zurich (CH)

Correspondence Address: MICHAEL J. BUCHENHORNER, 8540 S.W. 83 STREET, MIAMI, FL, 33143, US

(73) Assignee: Point Pay International, Inc.

(21) Appl. No.: 11/292,860

(22) Filed: Dec. 2, 2005

(51) Int. Cl. G06Q 30/00

(52) U.S. Cl. 705/14

(57) ABSTRACT

According to one embodiment a point of sale terminal includes: a housing having a plurality of sides; and the housing one or more panels along the sides of the displaying advertising. Another embodiment is a method for displaying advertising to the public by applying an advertisement for a product or service on the side of a point of sale terminal.

### FIELD OF THE INVENTION

The invention disclosed broadly relates to the field of point of sale terminals.

### BACKGROUND OF THE INVENTION

In a competitive world of advertising getting the right message to the right client is very important. Many purchases are done on point of sales terminals. Therefore, there is a need for advertising on the point of sale terminal.

### SUMMARY OF THE INVENTION

Briefly, according to an embodiment of the invention, a point of sale terminal includes: a housing having a plurality of sides; and the housing one or more panels along the sides of the displaying advertising. Another embodiment is a method for displaying advertising to the public by applying an advertisement for a product or service on the side of a point of sale terminal.

### BRIEF DESCRIPTION OF THE DRAWINGS

FIG. 1 is a point of sale terminal according to an embodiment of the invention.

FIG. 2 is the point of sale terminal with a removable advertising panel in the side of the terminal facing the consumer.

FIG. 3 is the point of sale terminal showing the side panels.

FIG. 4 is the point of sale terminal showing another view of the side panels.

FIG. 5 is the point of sale terminal showing a panel that shows advertisement.

### DETAILED DESCRIPTION

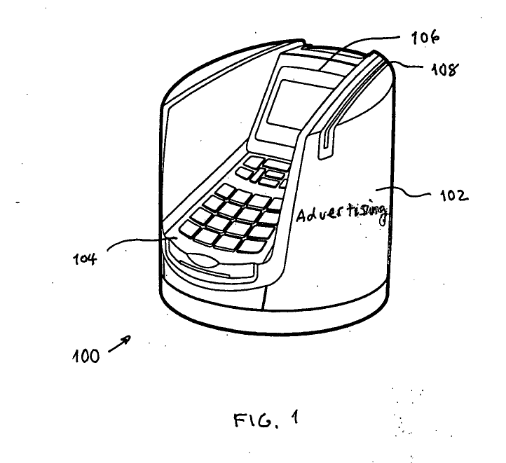

Referring to FIG. 1, there is shown a perspective view of a point of sale terminal 100 having panel 102 for displaying advertising on a side of the terminal 100.

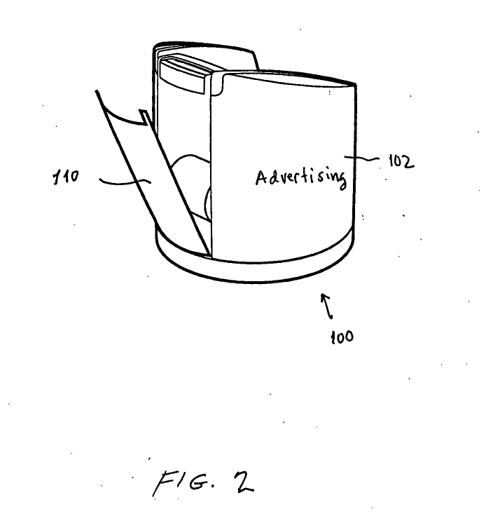

FIG. 2 is the point of sale terminal with a removable advertising panel 110 in the side of the terminal facing the consumer.

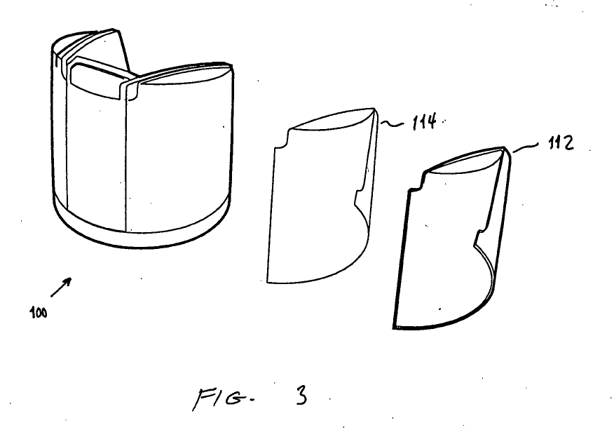

FIG. 3 is the point of sale terminal showing the side panels 112 and 114. The panel 114 is a panel where the advertising materials are printed thereon. It can be made of cardboard and fits on the side of the terminal 100. A second panel 112 is transparent and fits over the first panel 114.

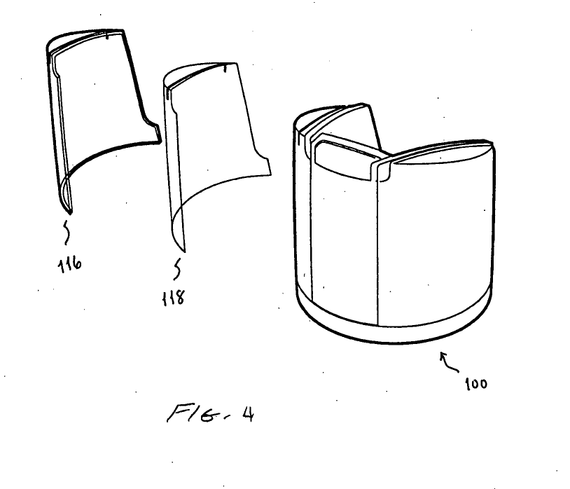

FIG. 4 is the point of sale terminal 100 showing another set of side panels 116 and 118.

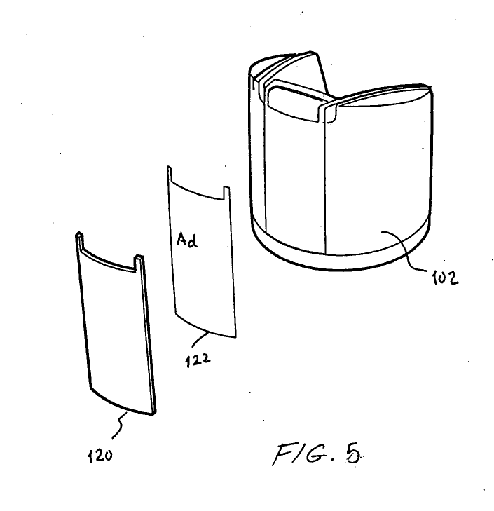

FIG. 5 is the point of sale terminal 100 showing a panel that shows advertisement in the side of the terminal facing the user.

Therefore, while there has been described what is presently considered to be the preferred embodiment, it will understood by those skilled in the art that other modifications can be made within the spirit of the invention.

We claim:

1. A point of sale terminal comprising:
a housing having a plurality of sides; and
the housing one or more panels along the sides of the displaying advertising.

2. The point of sale terminal of claim 1, wherein the housing comprises a cylindrical shape.

3. The machine of claim 1, wherein the housing comprises a keyboard.

4. The machine of claim 1, wherein the terminal comprises a display.

5. The machine of claim 1, wherein the panels are removable.

6. The machine of claim 1, wherein each side comprises a panel portion containing the advertisement and a transparent portion that fits over the advertisement.

7. A method comprising:
displaying an advertisement on a panel on a side of a point of sale terminal for displaying text to the public.

8. The method of claim 7 further comprising a step of leasing a space on a point of sale terminal wherein the space comprises advertising.

9. The method of claim 7 further comprising a step of leasing a space on a point of sale terminal wherein the space comprises images.

10. The method of claim 7 further comprising a step of leasing a space on a point of sale terminal wherein the space comprises images.
